(19) United States
(12) Patent Application Publication
(10) Pub. No.: US 2009/0116505 A1
(43) Pub. Date: May 7, 2009

(54) Service Based VLAN Stacking

(75) Inventors: Jagjeet Bhatia, Newbury Park, CA (US); Yogesh Petkar, Woodland Hills, CA (US); Ignatius Santoso, Thousand Oaks, CA (US)

Correspondence Address: Law Office of WILLIAM J. TUCKER, 2631 Lakeforest Ct., Dallas, TX, 75214, US

(73) Assignee: Alcatel Lucent, Paris (FR)

(21) Appl. No.: 12/258,230

(22) Filed: Oct. 24, 2008

Related U.S. Application Data
(60) Provisional application No. 60/986,136, filed on Nov. 7, 2007.

(51) Int. Cl. H04L 12/56

(52) U.S. Cl. 370/419

(57) ABSTRACT

A device and method are described herein for group profiling traffic (e.g., voice, data, high-speed data, video, multicast stream) which is received at a plurality of incoming ports. In one embodiment, the method includes the steps of: (a) receiving different types of traffic at the plurality of ports; (b) classifying the different types of traffic into different types of service access points; and (c) applying profiles of the different types of service access points to the corresponding different types of traffic, wherein the same type of traffic which is received by at least two ports of the plurality of ports will share the profile of the corresponding classified service access point.

### CLAIMING BENEFIT OF PRIOR FILED U.S. APPLICATION

This application claims the benefit of U.S. Provisional Application Ser. No. 60/986,136 filed on Nov. 7, 2007. The contents of this document are hereby incorporated by reference herein.

### TECHNICAL FIELD

The present invention is related to the communications field and, in particular, to a device and method for group profiling traffic (e.g., voice, data, high-speed data, video, multicast stream) which is received at a plurality of incoming ports.

### DESCRIPTION OF RELATED ART

Service providers of Internet or Virtual Private Network (VPN) connectivity are constantly trying to improve their equipment-service as it relates to the classification and control of their customer traffic (e.g., voice, data, high-speed data, video, multicast stream). An enhancement of the service provider's equipment-service to improve the classification and control of their customer traffic is the subject of the present invention.

### SUMMARY

In one aspect, the present invention provides a method for group profiling traffic which is received at a plurality of ports. The method includes the steps of: (a) receiving different types of traffic at the plurality of ports; (b) classifying the different types of traffic into different types of service access points; and (c) applying profiles of the different types of service access points to the corresponding different types of traffic, wherein the same type of traffic which is received by at least two ports of the plurality of ports will share the profile of the corresponding classified service access point.

In another aspect, the present invention provides a device including: (a) a plurality of ports; (b) a processor; and (c) a memory that stores processor-executable instructions where the processor interfaces with the memory and executes the processor-executable instructions to enable the following: (i) receiving different types of traffic at the plurality of ports; (ii) classifying the different types of traffic into different types of service access points; and (iii) applying profiles of the different types of service access points to the corresponding different types of traffic, wherein the same type of traffic which is received by at least two ports of the plurality of ports will share the profile of the corresponding classified service access point.

Additional aspects of the invention will be set forth, in part, in the detailed description, figures and any claims which follow, and in part will be derived from the detailed description, or can be learned by practice of the invention. It is to be understood that both the foregoing general description and the following detailed description are exemplary and explanatory only and are not restrictive of the invention as disclosed.

### BRIEF DESCRIPTION OF THE DRAWINGS

A more complete understanding of the present invention may be obtained by reference to the following detailed description when taken in conjunction with the accompanying drawings wherein:

FIG. 1 is a block diagram of a service centric VLAN stacking model which is used to explain how one or more devices incorporated therein can be configured in accordance with an embodiment of the present invention;

FIG. 2 is a flowchart illustrating the basic steps of a method for classifying multiple types of incoming traffic which are received at multiple ports in accordance with an embodiment of the present invention;

FIG. 3 is a flowchart illustrating the basic steps of a method for determining what kind of bandwidth control metering is to be applied to each of the different types of classified incoming traffic in accordance with an embodiment of the present invention; and

FIG. 4 is a diagram used to explain an exemplary scenario in which the device shown in FIG. 1 implements the methods shown in FIGS. 2 and 3 in accordance with an embodiment of the present invention.

### ABBREVIATIONS

CVLAN Customer VLAN
DSCP Diff-Serv Code Point
GVRP Generic Attribute Registration Protocol
MBPS Mega Bits Per Second
NNI Network Network Interface
SAP Service Access Point
STP Spanning Tree Protocol
SVLAN Service Provider VLAN
UNI User Network Interface
VLAN Virtual Local Area Network
VPN Virtual Private Network

### DETAILED DESCRIPTION

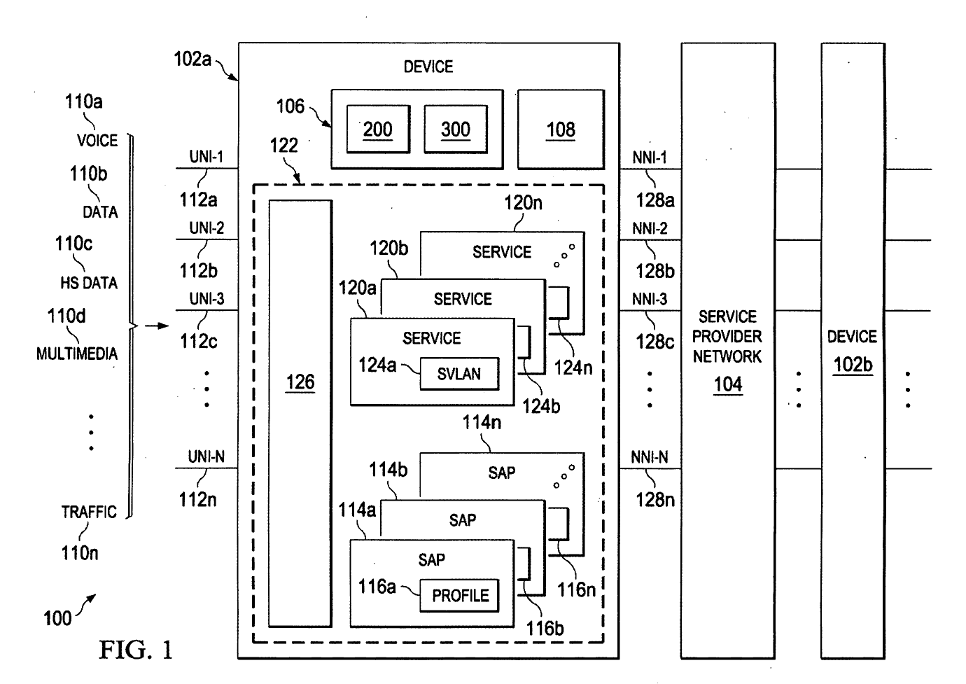

Referring to FIG. 1, there is a block diagram of a service centric VLAN stacking model 100 which is used to explain how one or more devices 102a and 102b are configured to implement group profiling methods 200 and 300 in accordance with an embodiment of the present invention. As shown, this exemplary service centric VLAN stacking model 100 includes a service provider network 104 at which there is coupled the two devices 102a and 102b (more than two devices 102a and 102b are possible). The two devices 102a and 102b each have essentially the same components and same functionality and as such for clarity only one device 102a will be described in detail hereinafter. Furthermore, in the interest of clarity it will be apparent to one having ordinary skill in the art that a description of well-known components and functionalities in the service centric VLAN stacking model 100 have been omitted so as not to obscure the description of the present invention.

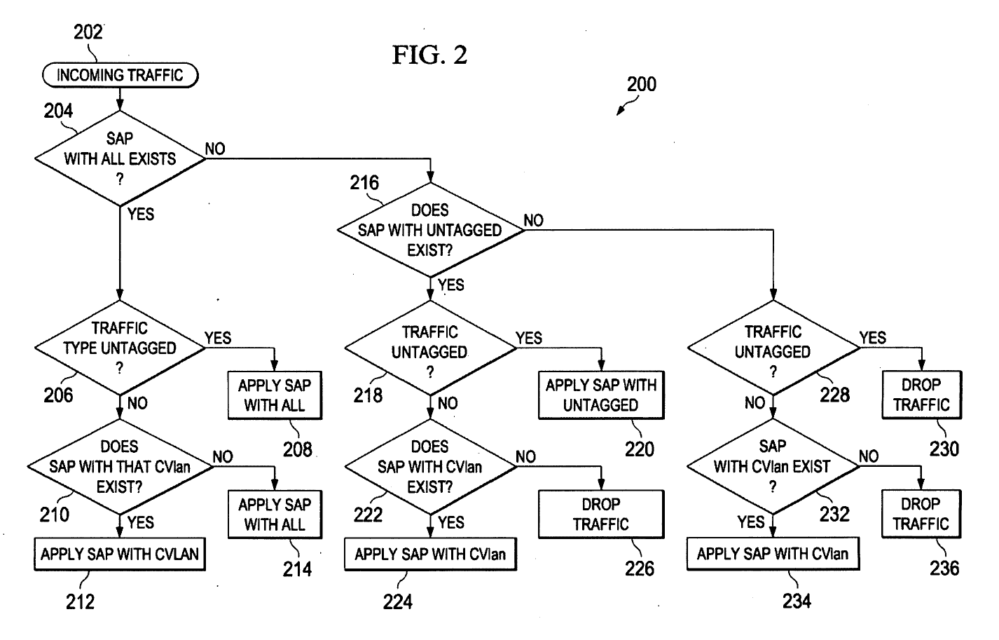

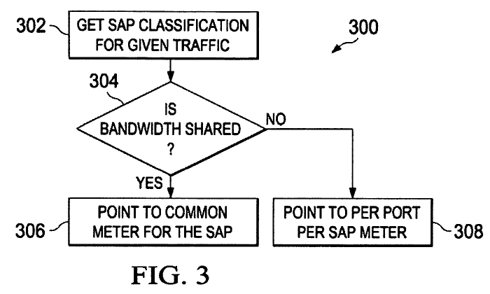

The device 102a has a processor 106 and a memory 108 that stores processor-executable instructions where the processor 166 interfaces with the memory 108 and executes the processor-executable instructions to implement the group profiling methods 200 and 300 by performing the following operations: (a) receiving different types of traffic 110a, 110b . . . 110n (e.g., voice 110a, data 110b, high-speed data 110c, multicast stream 110d) at one or more incoming ports 112a, 112b . . . 112n (e.g., UNI-1, UNI-2 . . . UNI-N); (b) classifying the different types of traffic 110a, 110b . . . 110n into different types of SAPs 114a, 114b . . . 114n (see FIG. 2); and applying profiles 116a, 116b . . . 116n of the different types of SAPs 114a, 114b . . . 114n to the corresponding different types of traffic 110a, 110b . . . 110n, wherein the same type of traffic 110d (for example) which is received by at least two ports 112a and 112b (for example) will share the profile 116d (for example) of the corresponding SAP 114d (which is associated with a multicast stream service) (see FIG. 3).

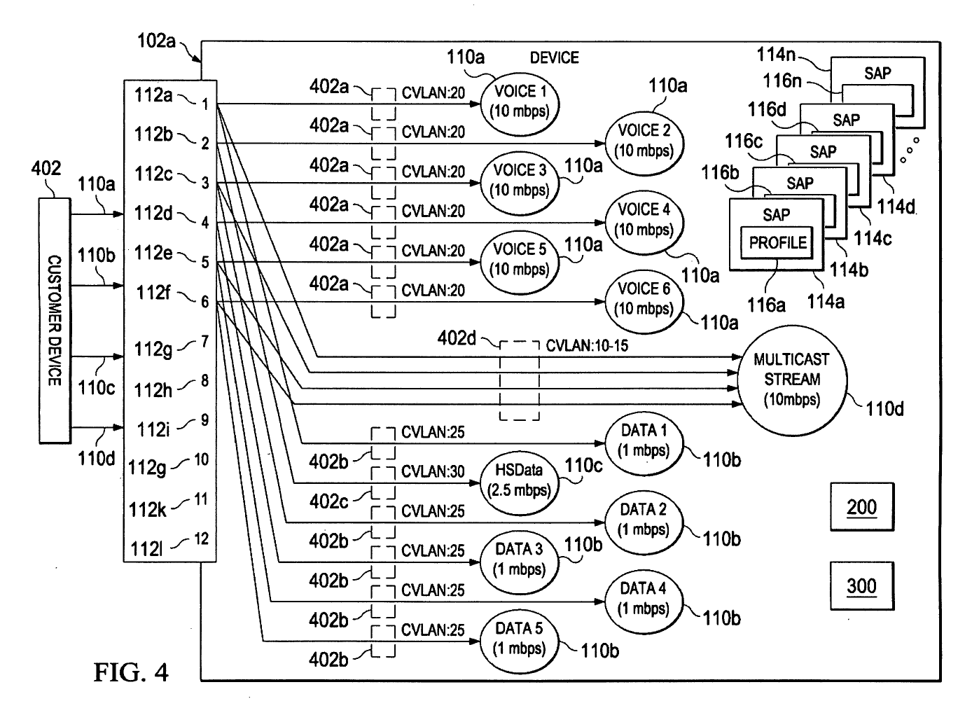

This is desirable since in the state-of-the-art there is no way to implement a group profile where a certain type of traffic 110a, 110b . . . 110n (e.g., voice 110a) which is received by multiple ports 112a, 112b . . . 112n (e.g., ports 112a and 112b) can share one profile 116a, 116b . . . 116n (e.g., profile 116a) of a specific SAP 114a, 114b . . . 114n (e.g., SAP 114a). The one profile 116a (for example) can then apply policies which enable a great deal of flexibility where for instance the voice traffic 110a (for example) received at ports 112a and 112b (for example) can share a specified amount of bandwidth (see FIG. 4). In the past, this was not possible since each port was configured to implement their own SAP profiles for received traffic and there was no effective way of grouping multiple ports which receive the same types of traffic to share the same SAP profile. A detailed discussion is provided next to explain one way how the device 102a can implement the group profiling methods 200 and 300 in accordance with an embodiment of the present invention.

In operation, the device 102a implements one or more services 120a, 120b . . . 120n each of which is a unique entity that refers to a type of connectivity service (e.g., voice, data, high-speed data, video, multicast stream) for either Internet or VPN connectivity. Each service 120a, 120b . . . 120n is uniquely identified by a service ID that unifies logical service entities 122 which are required to have the incoming traffic 110a, 110b . . . 110n flow as desired. In the service model, the logical service entities 122 provide a uniform, service-centric configuration and management model for service provisioning. The logical service entities 122 in this exemplary model include:
SVLAN(s) 124a, 124b . . . 124n—Service provider VLAN through which flows the customer traffic 110a, 110b . . . 110n.
SAP(s) 114a, 114b . . . 114n—Point(s) where the customer traffic 110a, 110b . . . 110n ingress or egress the device 102a.
SAP attribute profile(s) 116a, 116b . . . 116n—Attributes associated with SAP(s) 114a, 114b . . . 114n are applied to the customer traffic 110a, 110b . . . 110n and are reusable. For instance, the SAP attribute profile(s) 116a, 116b . . . 116n can control the following parameters:
   Profile name—name of profile for identification.
   Customer VLAN tag behavior—Determine whether to preserve or translate the tag of incoming customer traffic 110a, 110b . . . 110n.
   Priority mapping—Determine whether to preserve user priority by mapping a customer VLAN tag priority value to a service provider VLAN tag priority value, or by mapping a customer DSCP value to a service provider VLAN tag priority value, or by defining a user fixed priority for a service provider VLAN tag priority value.
   Ingress-bandwidth—Determine the limit on bandwidth for ingress traffic. For instance, granularity is 1 Mbps and the upper limit is determined by the maximum port capacity.
   Bandwidth-sharing—Determine whether to share specified bandwidth across all UNIs 112a, 112b . . . 112n within a specific SAP 114a, 114b . . . 114n or to not share bandwidth and let the limit be applied on each UNI 112a, 112b . . . 112n within a specific SAP 114a, 114b . . . 114n (see FIGS. 3-4).
UNI attribute profile 126—Attributes associated with UNI(s) 112a, 112b . . . 112n are applied to the customer traffic 110a, 110b . . . 110n through this profile. The UNI attribute profile 126 defines the behavior of all control packets entering a specific UNI 112a, 112b . . . 112n and this profile can be reused for all the ports 112a, 112b . . . 112n which require similar behavior. A separate UNI attribute profile 126 needs to be created if a different behavior is desired. For instance, the UNI attribute profile 126 can control the following parameters:
   Profile name—name of profile for identification.
   STP—Behavior of spanning tree protocol packets entering the UNIs 112a, 112b . . . 112n. Options are tunnel, drop.
   802.1x—Behavior of 802.1x protocol packets entering the UNIs 112a, 112b . . . 112n. Options are tunnel, drop or peer.
   802.1AB—Behavior of 802.1AB protocol packets entering the UNIs 112a, 112b . . . 112n. Options are tunnel, drop or peer.
   802.3ad—Behavior of 802.3AD protocol packets entering the UNIs 112a, 112b . . . 112n. Options are drop or peer.
   GVRP—Behavior of GVRP protocol packets entering the UNIs 112a, 112b . . . 112n. Options are tunnel, drop or peer.

Each service 120a, 120b . . . 120n in addition to the above-mentioned logical service entities 122 would have the following physical entities:
UNI(s) 112a, 112b . . . 112n—Physical interface(s) which are part of the SAPs 114a, 114b . . . 114n.
NNI(s) 128a, 128b . . . 128n—Physical interface(s) through which customer traffic 110a, 110b . . . 110n enters the service provider network 104.

For a service to function and provide connectivity in the device 102a the above entities would be connected to one another as follows: (1) the UNI(s) 112a, 112b . . . 112n are bound to SAP(s) 114a, 114b . . . 114n; (2) the SAP(s) 114a, 114b . . . 114n are bound to the service(s) 120a, 120b . . . 120n (note: there are also SAP(s) 114a, 114b . . . 114n which are bound to traffic type where the type of traffic 110a, 110b . . . 110n includes CVLAN ID tagged traffic or untagged traffic); (3) the service(s) 120a, 120b . . . 120n are bound to SVLAN(s) 124a, 124b . . . 124n; and (4) the SVLAN(s) 124a, 124b . . . 124n are bound to NNI(s) 128a, 128b . . . 128n. A discussion about one way that the device 102a can classify the different types of traffic 110a, 110b . . . 110n (which are received by the UNIs 112a, 112b . . . 112n) into different types of SAPs 114a, 114b . . . 114n is described next with respect to FIG. 2.

Referring to FIG. 2, there is a flowchart illustrating the basic steps of a method 200 for classifying multiple types of incoming traffic 110a, 110b . . . 110n which are received at multiple UNIs 112a, 112b . . . 112n in accordance with an embodiment of the present invention. Beginning at step 202, incoming traffic 110 is received at one or more UNIs 112. The incoming traffic 110 can be tagged with a CVLAN ID or the incoming traffic 110 can be untagged traffic. At step 204, a determination is made whether an “all” SAP 114 exists for all types of traffic 110. If yes, then at step 206 a determination is made whether the incoming traffic 110 is untagged. If yes, then at step 208 apply the “all” SAP 114 for the incoming traffic 110. If no, then at step 210 a determination is made whether a “CVLAN” SAP 114 exists which matches the incoming traffic 110. If yes, then at step 212 apply the “CVLAN” SAP 114 for the incoming traffic 110. If no, then at step 214, apply the “all” SAP 114 for the incoming traffic 110.

Referring back to step 204, if the result is no then at step 216 a determination is made whether an “untagged” SAP 114 exists. If yes, then at step 218 a determination is made as to whether the traffic 110 is untagged. If yes, then at step 220 apply the “untagged” SAP 114 for the incoming traffic 110. If no, then at step 222 a determination is made as to whether a “CVLAN” SAP 114 exists which matches the incoming traffic 110. If yes, then at step 224 apply the “CVLAN” SAP 114 for the incoming traffic 110. If no, then at step 226 drop the incoming traffic 110.

Referring back to step 216 if the result is no then at step 228 a determination is made whether the incoming traffic 110 is untagged. If yes, then at step 230 drop the incoming traffic 110. If no, then at step 232 a determination is made whether a “CVLAN” SAP 114 exists which matches the incoming traffic 110. If yes, then at step 234 apply the “CVLAN” SAP 114 for the incoming traffic 110. If no, then at step 236 drop the incoming traffic 110. Thus, it can be seen how method 200 enables the classification of incoming traffic 110 into different SAPs 114 based on whether or not the incoming traffic 110 is CVLAN tagged traffic 110 or untagged traffic 110. The method 200 can also accommodate multiple types of CVLAN SAPs 114 and multiple types of CVLAN incoming traffic 110, but for clarity only the “generic” CVLAN SAP 114 and CVLAN tagged traffic 110 was discussed in FIG. 2 (see FIG. 4).

Referring to FIG. 3, there is a flowchart illustrating the basic steps of a method 300 for determining what kind of bandwidth control metering is to be applied to each of the different types of classified incoming traffic 200 in accordance with an embodiment of the present invention (note: the metering method 300 would be performed after the aforementioned classification method 200). At step 302, obtain the classification of the particular SAP 114 that was associated with the incoming traffic 110. For instance, the CVLAN SAP 114 is associated with CVLAN tagged incoming traffic 110, and the untagged SAP 114 is associated with untagged incoming traffic 110. At step 304, a determination is made as to whether the bandwidth is to be shared for all of the incoming traffic 110 associated with a particular SAP 114. If yes, then at step 306 point this particular incoming traffic 110 to a common bandwidth control meter that is associated with all of the incoming ports 112a, 112b . . . 112n which are configured to receive that particular type of incoming traffic 110. For instance, all the data traffic 110 having the same CVLAN tag which is received by two or more ports 112a and 112b (for example) will be classified to the same CVLAN SAP 114 and as such that data traffic 110 would share that SAP's profile 116a which indicates that a common meter is to be used to share a certain amount of bandwidth for the data traffic 110. If the result of step 304 is no, then at step 308 point the particular incoming traffic 110 received at one port 112 to one meter and the particular incoming traffic 110 received at another port 112 to another meter such that each port 112 has its own meter for controlling the bandwidth of its own received incoming traffic 110.

Referring to FIG. 4, there is a diagram which is used to explain an exemplary scenario in which the device 102a implements methods 200 and 300 in accordance with an embodiment of the present invention. In this scenario, the device 102a classifies incoming traffic 110a, 110b, 110c and 110d into different SAPs 114a, 114b, 114c and 114d and then controls various parameters of the classified incoming traffic 110a, 110b, 110c and 110d. The main parameters controlled in this scenario are priority and bandwidth where the bandwidth for traffic 110 with a specific CVLAN tag can be shared across multiple ports 112a, 112b . . . 112l (in this scenario referred to as ports 1, 2, . . . 12) while at the same time the ports 112a, 112b . . . 112n can each provide dedicated bandwidth to traffic 110 which has a different CVLAN tag.

In this scenario, there are four types of streaming incoming traffic 110a, 110b, 110c and 110d which are as follows:
Voice 110a—Configured on incoming ports 1, 2, 3, 4, 5, and 6.
Data 110b—Configured on incoming ports 1, 3, 4, 5, and 6.
High Speed Data 110c—Configured on incoming port 2.
Multicast Stream 110d—Configured on incoming ports 1, 3, 5, and 6.

In this scenario, assume there is a remote customer device 400 which would tag these particular streams of traffic as follows: (1) voice traffic 110a with CVLAN:20 tag; (2) data traffic 110b with CVLAN:25 tag; (3) high speed traffic 110c with CVLAN:30 tag; and (4) multicast traffic 110d with CVLAN:10-15 tag;. Thus, the device 102a upon receiving the incoming traffic 110a, 110b, 110c and 110d at the respective port(s) 1, 2, 3, 4, 5, and 6 would implement method 200 and classify the traffic as follows: (1) voice traffic 110a with CVLAN:20 SAP 114a; (2) data traffic 110b with CVLAN:25 SAP 114b; (3) high speed traffic 110c with CVLAN:30 SAP 114c; and (4) multicast traffic 110d with CVLAN:10-15 SAP 114d. Thereafter, the device 102a applies the SAP's profiles 116a, 116b, 116c and 116d to the corresponding classified streams of traffic 110a, 110b, 110c and 110d. Assume that the SAP's profiles 116a, 116b, 116c and 116d have the following policies:
Profile 116a—bandwidth requirement for the voice traffic 110a is a dedicated 10 mbps per port.
Profile 116b—bandwidth requirement for the data traffic 110b is a dedicated 1 mbps per port.
Profile 116c—bandwidth requirement for the high speed data 110c is a dedicated 1.5 mbps per port.
Profile 116d—bandwidth requirement for the multicast stream 110d is 10 mbps shared across all participating ports.

In this scenario, the device 102a when applying the SAP's profiles 116a, 116b, 116c and 116d would implement method 300 so as to control the bandwidth of the incoming traffic 110a, 110b, 110c and 110d. Thus, the device 102a would utilize multiple bandwidth control meters 402a, 402b, 402c and 402d as follows:
Six dedicated meters 402a one for each voice traffic 110a that is received at each port 1, 2, 3, 4, 5 and 6 in the CVLAN:20 SAP 114a.
Five dedicated meters 402b one for each data traffic 110b that is received at each port 1, 3, 4, 5, 6 in the CVLAN: 25 SAP 114b.
One dedicated meter 402c for the high speed data traffic 110c that is received at port 2 in the CVLAN:30 SAP 114c.
One shared meter 402d for the multicast streams 110d received at all of the ports 1, 3, 5 and 6 in the CVLAN:10-15 SAP 114d.

As can be seen, the device 102a in implementing methods 200 and 300 enables bandwidth control across a group of ports, per port, per port per VLAN or per group of ports per VLAN, which provides a very granular approach to metering and controlling of user traffic 110a, 110b . . . 110n which is especially desirable in an access type of environment. Plus, with more and more vendors entering into the triple play market (providing Internet, television and phone service), they will need to provide controlled access on the ports connecting to the set-top boxes (consumer premise equipment) which are located inside the customer's house. Thus, by providing the present invention, the service providers will now be able to enable or disable services, control customer traffic at a granular level and classify customer traffic for the required service. In short, the present invention gives service providers the flexibility they need to offer different types and levels of services depending on the customer's requirements.

Although one embodiment of the present invention has been illustrated in the accompanying Drawings and described in the foregoing Detailed Description, it should be understood that the present invention is not limited to the disclosed embodiment, but is capable of numerous rearrangements, modifications and substitutions without departing from the invention as set forth and defined by the following claims.

1. A method for group profiling traffic which is received at a plurality of ports, said method comprising the steps of:
receiving different types of traffic at the plurality of ports;
classifying the different types of traffic into different types of service access points; and
applying profiles of the different types of service access points to the corresponding different types of traffic, wherein the same type of traffic which is received by at least two ports of the plurality of ports will share the profile of the corresponding classified service access point.

2. The method of claim 1, wherein the received traffic includes at least one of the following types:
voice;
data;
high speed data;
video; and
a multicast stream.

3. The method of claim 1, wherein the classifying step further includes a step of using a virtual local area network, VLAN, tag in the received traffic to classify the different types of the traffic into the different types of service access points.

4. The method of claim 1, wherein the classifying step further includes a step of dropping any received traffic which could not be classified into one of the different types of service access points.

5. The method of claim 1, wherein the applying step further includes using a common meter to share bandwidth for the same type of traffic received by the at least two ports, where the use of the common meter is defined by the profile of the corresponding classified service access point.

6. The method of claim 1, wherein the applying step further includes using at least two dedicated meters to control bandwidth for the same type of traffic received by the at least two ports, wherein one of the at least two dedicated meters is used for the traffic that is received by one of the at least two ports, wherein another one of the at least two dedicated meters is used for the traffic that is received by another one of the at least two ports, and wherein the use of the at least two dedicated meters is defined by the profile of the corresponding classified service access point.

7. A device, comprising:
a plurality of ports;
a processor;
a memory that stores processor-executable instructions where the processor interfaces with the memory and executes the processor-executable instructions to enable the following:
receiving different types of traffic at the plurality of ports;
classifying the different types of traffic into different types of service access points; and
applying profiles of the different types of service access points to the corresponding different types of traffic, wherein the same type of traffic which is received by at least two ports of the plurality of ports will share the profile of the corresponding classified service access point.

8. The device of claim 7, wherein the received traffic includes at least one of the following:
voice;
data;
high speed data;
video; and
a multicast stream.

9. The device of claim 7, wherein the processor performs the classifying operation by using a virtual local area network, VLAN, tag in the received traffic to classify the different types of the traffic into the different types of service access points.

10. The device of claim 7, wherein the processor performs the classifying operation by dropping any received traffic which could not be classified into one of the different types of service access points.

11. The device of claim 7, wherein the processor performs the applying operation by using a common meter to share bandwidth for the same type of traffic received by the at least two ports, where the use of the common meter is defined by the profile of the corresponding classified service access point.

12. The device of claim 7, wherein the processor performs the applying operation by using at least two dedicated meters to control bandwidth for the same type of traffic received by the at least two ports, wherein one of the at least two dedicated meters is used for the traffic that is received by one of the at least two ports, wherein another one of the at least two dedicated meters is used for the traffic that is received by another one of the at least two ports, and wherein the use of the at least two dedicated meters is defined by the profile of the corresponding classified service access point.
